(19) United States
(12) Patent Application Publication
(10) Pub. No.: US 2008/0281548 A1
(43) Pub. Date: Nov. 13, 2008

(54) Method and System for Automatic Defect Detection of Articles in Visual Inspection Machines

(75) Inventors: Doran Algranati, Beit Shearim (IL); Oren Tropp, Nesher (IL); Roman Kagan, Haifa (IL)

Correspondence Address: DANN, DORFMAN, HERRELL & SKILLMAN, 1601 MARKET STREET, SUITE 2400, PHILADELPHIA, PA, 19103-2307, US

(73) Assignee: CAMTEK LTD, MIGDAL HEMEK (IL)

(21) Appl. No.: 11/718,049

(22) PCT Filed: Aug. 27, 2006
(86) PCT No.: PCT/IL06/00990

§ 371 Date: Apr. 26, 2007

Related U.S. Application Data
(60) Provisional application No. 60/711,425, filed on Aug. 26, 2005.

(30) Foreign Application Priority Data
Aug. 24, 2006 (IL) 177689

(51) Int. Cl. G06F 19/00

(52) U.S. Cl. 702/123

(57) ABSTRACT

There is provided a method for establishing a parameters setup for inspecting a plurality of articles by an automatic inspection system. The method includes inspecting a first article by the inspection system, applying an automatic defects detection method according to a given set of inspection parameters, receiving an initial map of defects and sorting uncovered defects into defect types according to a predetermined set of defect types. While sorting defects, if new defects not recognized by the inspection system are detected, adding the new defects to the initial map to be sorted and automatically setting the inspection parameters by means of applying computational dedicated algorithms, using a heuristic approach, to form a modified parameters setup. The modified parameters setup is then used for obtaining a modified map of detected defects, and the modified parameters setup for inspecting other of the plurality of articles. A system for establishing a parameters setup for inspecting a plurality of articles is also provided.

### FIELD OF THE INVENTION

The present invention relates to methods implemented in automatic visual inspection systems performed at intermediate process steps during repeated production of articles, and more particularly to methods for performing setup of inspection parameters in detecting defects by automatic inspection machines.

### BACKGROUND OF THE INVENTION

During production of articles involved with multiple sequential process steps, such as printed circuits, semiconductor devices, or complex mechanical elements, there is a need for inspection, verification, and quality control steps between the process steps. The intermediate verification is required, in order to detect faulty articles and avoid performing ineffective, expensive process steps over articles, possibly critically defected during one of the early process steps. In some cases, functional tests of the article may only be performed after completion of the entire production process. For this reason, intermediate visual inspection methods were developed, starting with manual visual inspection devices such as described in U.S. Pat. No. 4,691,426.

Another aspect related to volume manufacturing in automatic processes is a degree of correlation between the type of defect and its physical location (coordinates) on the article. Some Automatic Visual Inspection (AVI) techniques make use of this correlation by storing detected defect coordinates in a constantly updated database. The database is used to shorten and improve the inspection cycle of upcoming articles.

In such systems, for evaluating whether a detected defect is critical or not, it is required to complete at least a few articles and perform functional tests. As long as critical defects are repeatedly generated at the same location, this approach is acceptable, however, if a random or new local defect appears, the process of evaluating the criticality of the defect should start again, forming an unacceptable delay between defect generation to the automatic detection.

A second approach for visual inspection systems, proposes detection of defects by acquiring an image of the inspected article and analyzing it. This analysis is usually performed using image processing, morphologic and pattern recognition means. Each one of these means has its own intrinsic parameters, which will define the defects that the system will recognize. Upon the recognition, there might be a set of classifying rules, required in order to define whether the suspected defect is to be reported as a critical defect. The defects reported by the system can be subsequently visualized and/or fixed by the user, or automatically. Accurate distinction between critical defects and non-critical defects, however, is not simple and in order to accurately classify critical defects, samples are used for training the system. Preparing accurate critical defect samples for different types of defects generated in the production process through manual observation and classification, is difficult.

Moreover, various customers of such systems have different detection criteria for their various products. Certain patterns, which are regarded by one customer as critical defects, might be regarded by another customer as acceptable. Additionally, defects that should be reported in a fine product may present an acceptable quality in a courser product of the same customer. Moreover, different articles of the same product may have different representations in the acquired image, therefore requiring a different set of classifying rule parameters.

A third approach using a combination of the above-described methods is suggested in U.S. Pat. No. 7,062,081 providing a method of analyzing defects detected in the production process of an electronic circuit pattern. A defect on the inspected object is detected and the position information for this detected defect is stored. Detailed information on this defect is collected for this defect for which position information was stored. This collected detailed information is associated with a defect position information and stored. The inspected object is electronically tested and information positions at which faults are generated in this electronic test, are stored. The stored defect position information and the fault-generating position information are compared and the detected defect is classified based on the results of this comparison. Information relating to this classified defect is then displayed.

Drawbacks of the above-described third approach, include the requirement to verify position information by functional test results and the difficulty of setting up the classification rule in products other than semiconductor devices, where a wider image differentiation exists, as mentioned above with relation to the second approach. Another drawback relates to the difficulty of manually updating the classification rule, as will be explained below.

The importance that the system will report on all the critical defects is, of course clear, however, using over-sensitive sets of classification rule parameters will also result in reporting of non-critical defects. Such ignorable or false-recognized defects will eventually consume customer's resources pointlessly.

U.S. Pat. No. 6,674,888 deals with a process of setting parameters for the classification rule, suggesting repeated sequence of modifying the rule until the resulting criteria is satisfied.

As the above patents suggest, there might be subsequent stages in the setup of mentioned recognition, decision and reporting parameters, in order to meet specific detection criteria of each product, while receiving the best balance between critical and non-critical defects. An initial setup may be performed automatically, according to the products' designed features, however, such setup does not always result in receiving the best balance between critical and non-critical defects. This situation is caused for various reasons, including: a) that the characteristics of the image acquired from the inspected article cannot always be predicted in advance, and b) the existence of unexpected environmental conditions, such as dust particles, illumination conditions or the material's properties.

Since results of detection after the initial setup of the first article will then be applied to all subsequent articles in the batch, a more thorough subsequent setup is applied for optimizing the setup of the first article.

Presently, this subsequent setup is performed on the system itself, after scanning of the first article and receiving the initial defects map. This secondary setup, however, is manually performed by direct changing of recognition or decision and reporting parameters, or by changing of detection criteria, which will consequently influence these parameters.

As long as the setup is performed manually, it is limited by the amount of parameters that can be changed by a common user, and its results highly depend on the skills of the specific user and the user's familiarity with the inspecting system.

Consequently, a need has been identified for an automated intelligent method for setting up, refinement and modification of the classification rule in an automatic visual inspection process.

### SUMMARY OF THE INVENTION

A method and system is therefore proposed wherein the relation between a large set of processing, recognition, decision and reporting parameters, are to be optimized in parallel at short setup time automatically, and at constraints that are dictated before, during or after the inspection process. The optimization process proposed is based on a mathematical or cost function minimization scheme, which uses logical or heuristic or learned parameters of decision rules. The optimization process proposed also treats hierarchy of image spatial and color depth resolutions, and puts emphasis on a variety of image sources such as, imaging sensors, light sources, storage sources and network sources. The optimization process proposed also enables a user interaction for special learning processes (which are not done automatically), including special visualization and decision-making means.

The present invention also provides a method for facilitating the secondary setup process in automatic visual inspection systems, using semi-automatic or fully automatic machine learning concepts, thereby enhancing detection results and enabling non-skilled users to operate the system.

The method relies on the recognition that once an article from the batch (preferably, but not exclusively, the first article) has been inspected, an initial map of reported defects is established and the defects are sorted by criticality, thereafter recognition, decision and reporting parameters can be tuned automatically, in order to optimally meet the detection criteria defined by the sorting process.

Optionally, by performing sorting of additional defect maps, received from the inspection of subsequent articles from the batch, the earning process can be performed again, in order to further refine the tuning of parameters and further enhance detection results. Additionally, there is provided a method for performing this setup process from a remote location.

According to a preferred embodiment of the present invention, there is provided a method for establishing a parameters setup for inspecting a plurality of articles by an automatic inspection system, said method comprising the steps of inspecting a first article by said inspection system, applying an automatic defects detection method according to a given set of inspection parameters, receiving an initial map of defects, sorting uncovered defects into defect types according to a predetermined set of defect types, while sorting defects, if new defects not recognized by said inspection system are detected, adding said new defects to said initial map to be sorted, automatically setting said inspection parameters by means of applying computational dedicated algorithms, using a heuristic approach, to form a modified parameters setup, using the modified parameters setup for obtaining a modified map of detected defects, and using said modified parameters setup for inspecting other of said plurality of articles.

The present invention also provides a system for establishing a parameters setup for inspecting a plurality of articles, comprising an inspection system for inspecting a first article of a batch forming an initial map of defects, and a controller operative for receiving said initial map of defects from said inspection system, displaying each of said defects of said initial map enabling an operator to sort each defect by types of defects and to enter the sorting into the system, using dedicated algorithms to establish a modified parameters setup for receiving a modified defects map having a desirable ratio between true defects and false defects, and providing said parameters setup for inspecting other articles of said batch.

The present invention still further provides a system for automatic or semi-automatic establishing parameters setup for inspecting a plurality of articles, comprising a sensor for imaging a region of an inspected article, a detection mechanism for choosing locations on said article for elaboration or display, a memory capable of saving images of detected areas acquired by said sensor, a decision-making unit for obtaining an optimal defect map, a searching mechanism for finding parameter values that yield optimal results as defined by the decision-making unit, and means providing parameter values for inspecting other articles of said batch.

Thus, unlike the prior art methods and systems, according to the present invention parameters setup is such that it not only controls the image processing parameters but all parameters of the system, such as the illumination of the articles.

### BRIEF DESCRIPTION OF THE DRAWINGS

The invention will now be described in connection with certain preferred embodiments with reference to the following illustrative figures, so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow diagram presenting a method for semi-automatically tuning detection parameters of an automatic visual inspection system;

FIG. 2 is an example of sorting using an image acquired during initial inspection and stored in a memory;

FIG. 3 illustrates an example of sorting using live video acquisition;

FIG. 4 illustrates an optional method for choosing the best recognition/reporting for one parameter, and

FIG. 5 illustrates a further optional method for choosing the best recognition/reporting for one parameter.

### DETAILED DESCRIPTION OF THE PREFERRED EMBODIMENT

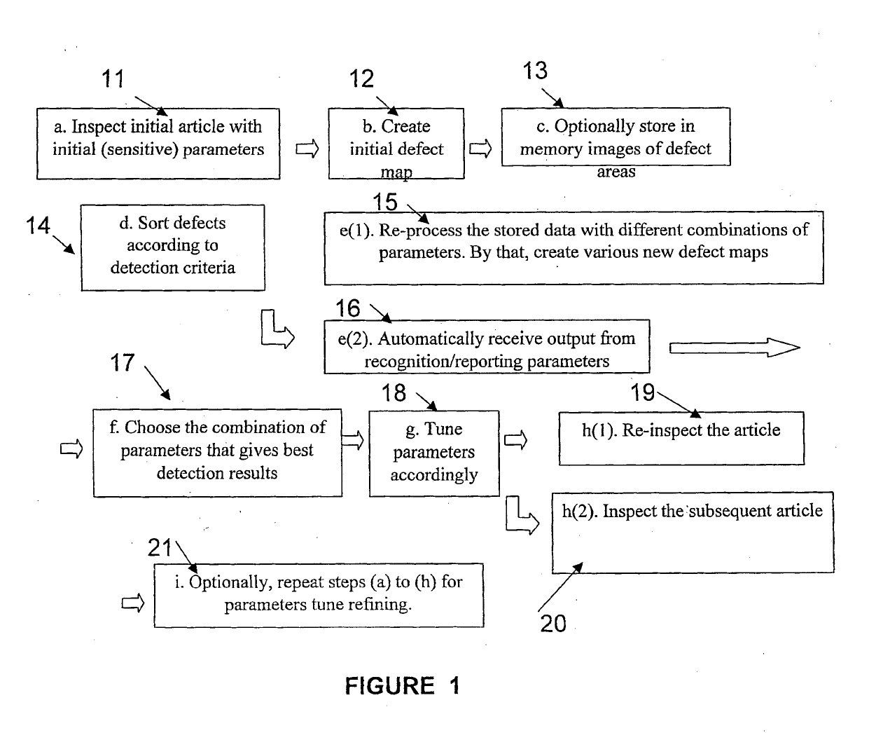

With reference to the drawings, FIG. 1 illustrates a flow diagram presenting a method for semi-automatic tuning of detection parameters in an automatic visual inspection system. The method is regarded as semi-automatic, as the decision of whether a defect received in the initial defect map is critical or non-critical, is performed manually by the user, preferably an experienced user such as the article's designer or automatically by the system. The flow between process steps is automatically sequenced by a controller.

In step (a) of block 11, the article, whether the first article in the batch or not, is inspected by scanning with an automatic optical inspection (AOI) system, using initial parameters. These initial parameters may be received either automatically, from initial setup or from default values within the system, or manually chosen from a parameter database. Preferably, a sensitive set of parameters is selected, such that it will result in detection of all critical defects, including some non-critical defects located on the article.

Using the mentioned initial set of parameters, in step (b), block 12, a map of defects that is chosen to be reported to the user is created. This initial defect map will include both critical and non-critical defects detected.

In step (c) of block 13, either during first or a subsequent step of the inspection, images of the defect areas are stored in memory devices, for subsequent analysis.

In the next step (d), of block 14, images representing the defects are shown to the user. These images may be either the images stored in the memory device, or images from another source including, but not exclusively, live acquisition.

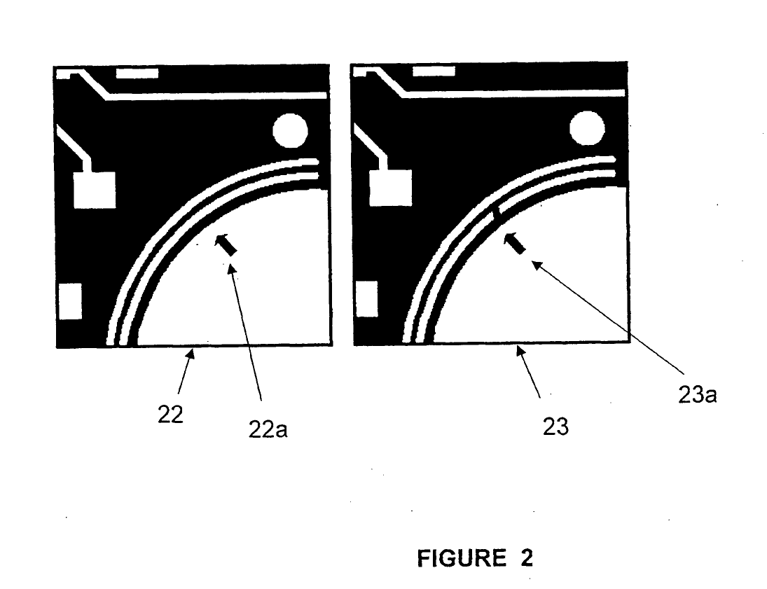

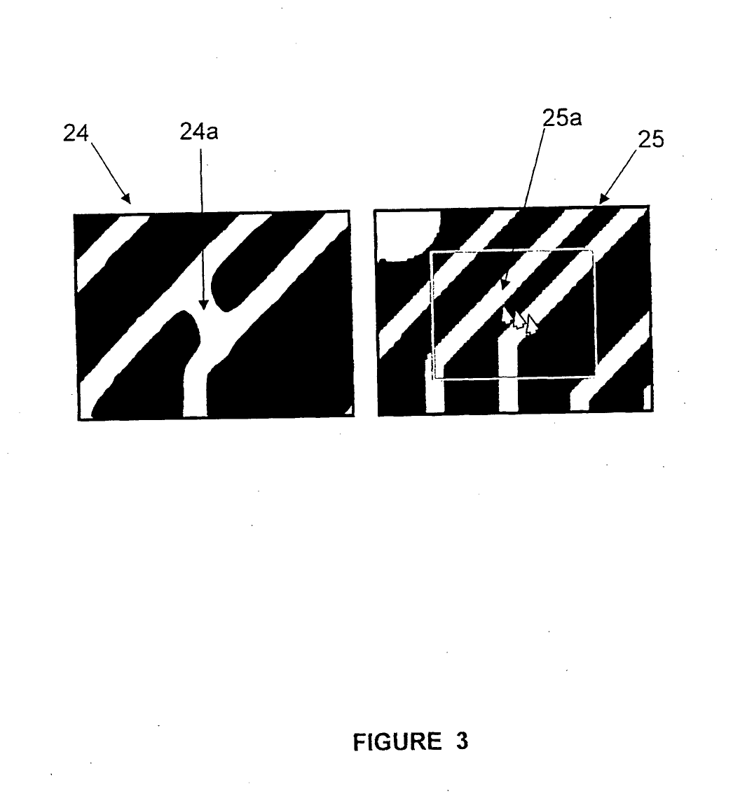

With reference now to FIGS. 2 and 3, an illustration of this sorting can be seen. Upon viewing these images, the user decides whether each of the defects is critical or not. Optionally, the user may decide that the detected defects need finer inspection. Additionally, the user may add manually detected defects that were not detected by the system. Advantageously, not only are defects presented to the user, but also locations, which could facilitate the automatic parameter's tuning. The described process of sorting the images can be performed from a remote location.

The process can be continued using one of the following options:
A) Step (e1), block 15: perform reprocessing of the stored images with different sets of parameters, thereby receiving new defect maps. Re-inspecting of the article is not required for the reprocessing, or
B) Step (e2), block 16: receive outputs from recognition/reporting means, in order to subsequently analyze it.

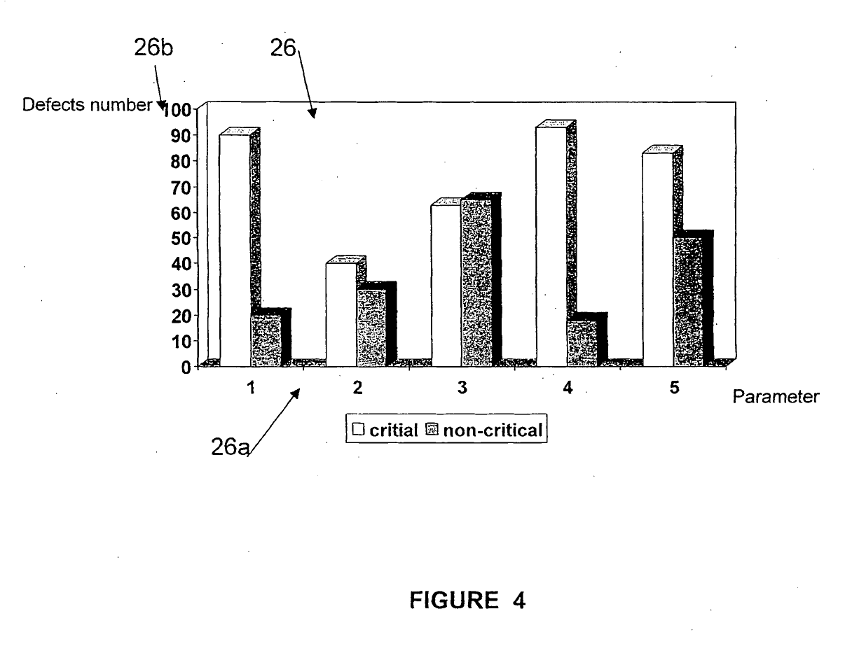

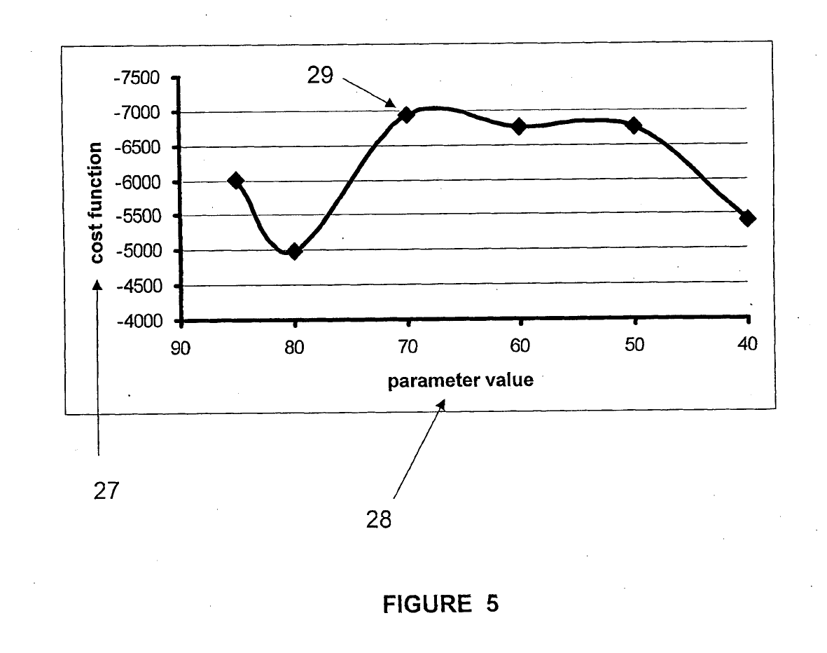

In block, 17, step (f) the system chooses the combination of parameters that give the best detection results, by means of applying certain computational dedicated algorithms, using a heuristic approach, to form a new parameters setup. During implementation of the heuristic approach, setups of various parameters are tested, each time, creating a new map of defects. The best defect map, and consequently, the best parameters setup, is chosen to be the new parameters setup. The heuristic approach algorithms may be applied in combination with a deterministic approach, in which upon receiving the sorted defects-map and the parameters of detection in some or each of sorted defects, each parameter is set, in order to attain the best new defect map. Dedicated rules are used to define a desirable ratio between defect types, the rules are set to obtain new parameters setups detecting a new map of defects, all of which are contained in a database of predefined types of defects. These rules are implemented using a mathematical function, or a logical function, or any combination thereof. One of the mathematical functions that may be used is a cost function. The best combination can be defined in a flexible manner. Optionally, a cost function on all combinations of parameters setups (as indicated in the example below), and finding it's extreme values, may be applied. The method for defining best parameters may be applied on each parameter separately, or on a group of parameters. FIGS. 4 and 5, which will be referred to hereinafter more specifically, illustrate the indications, by which parameters are chosen.

According to the next step (g), block 18, the system's initial recognition/reporting parameters are automatically tuned according to the above-chosen parameters. The process can then be continued using one of the following options:
A) Step (h1), block 19: re-inspect the same article with the new set of parameters, receiving a new defect map with better detection results, and
B) Step (h2), block 20: proceed to inspect the subsequent article with the new set of parameters.

Advantageously, in step (i), block 21, steps (a) to (h) are repeated for refining the tuning of parameters.

The fully automatic tuning method is identical to the semi-automatic tuning, except for the fact that the sorting, step (d) block 14, is performed automatically, using higher resolution images, higher computational resources, or longer elaboration time than in the rest of the work flow. Higher resolution images may either be images with higher color resolution, spatial resolution, or both. In such a case, the only manual stage in the previously described workflow is performed automatically.

With reference to FIG. 2, there is shown an example of sorting, using an image 22 in an area 22a which was acquired during initial inspection and stored in the memory. An image defect area 23 with a suspected defect 23a is displayed adjacent to the correct image 22. The image 22 of the reference article is optionally added to the database, in order to enhance further detection of the detected defect. Mathematical filters can be applied on the image in order to enhance the visualization of the defect. Optionally, the sorting is performed from a remote location.

FIG. 3 illustrates an example of sorting using live video acquisition. An image of the defect area 24 is displayed showing the defect 24a. Optionally, an image of the reference article 25 with the correct form 25a is added to the database, in order to enhance further detection of the detected defect. Mathematical filters can be applied on the image in order to enhance the visualization of the defect. Optionally, the sorting is performed from a remote location.

FIG. 4 illustrates a preferred method for choosing the best recognition/reporting parameters. For each parameter to be tuned, a chart 26 is built. The X-axis (26a) of these charts 26, represents the values of the tunable parameter, whereas the Y-axis (26b), represents the number of critical and non-critical defects detected when changing this parameter. Additional dependent parameters may be added to these charts.

FIG. 5 illustrates a preferred method for choosing the best recognition/reporting parameters. By applying a certain cost function on each separate parameter, or on a group of parameters, a value of cost is defined for each value of parameter or combination of parameters. By finding the extreme values of cost, the most suitable parameters can be extracted and inserted into the inspecting system. This figure illustrates and displays the cost function 27 as the function of a selected parameter value 28 where at the best selected 29, maximum critical faults and minimal non-critical faults are obtained.

In order to demonstrate the utilization of cost function for choosing parameters, the following example can be used:

Assuming cost function can be described as—A*(Critical defect)+B*(Non-critical defect)+C*(Change from original value of parameter)+D*(added non sorted defects due to change of parameter).
Assuming A=1000, B=10, C=5, D=20.
Assuming original value of parameter was 60.
Assuming the following table of results (see also FIG. 5):

| Value | 40 | 50 | 60 | 70 | 80 | 85 |
|---|---|---|---|---|---|---|
| Critical | 6 | 7 | 7 | 7 | 5 | 6 |
| Non critical | 20 | 15 | 25 | 10 | 2 | 10 |
| Added | 15 | 2 | — | 1 | 5 | 1 |

Application of cost function will result in:

| Value | 40 | 50 | 60 | 70 | 80 | 85 |
|---|---|---|---|---|---|---|
| Cost | −5400 | −6760 | −6750 | −6930 | −4980 | −6005 |

Therefore, for obtaining optimal results, the system will choose the value of 70 (the value with the lowest cost) for this parameter.

The invention also provides a system for implementing the described method, including an inspection system for inspecting an article of a batch, to establish an initial map of defects, and a controller operative for receiving the initial map of defects from the inspection system and displaying each of the defects in front of an operator. The system enables the operator to sort each defect by type. The controller then applies the above-described dedicated algorithms on the collected sorting, to establish a new parameters setup for subsequent inspecting. By using the new parameters, an improved defect map is obtained with a desirable ratio between true defects and false defects. The new parameters setup is used for inspecting the remaining articles of the batch.

The inspection system further comprises a sensor for imaging a region of the inspected article, a detection mechanism for choosing locations to elaborate or to display memory component, and a decision-making mechanism consisting of guidelines or rules meant for defining the optimal result searched for. A searching mechanism is further included for finding the parameters' values that yield optimal results, as defined by the decision-making mechanism, and means required for providing the parameters' values for inspecting the remaining articles in the batch.

The system may utilize any optical sensor, sensitive to visible, color or gray-level light, or to other parts of the electromagnetic spectrum, optionally a line or array of TDI sensors.

The detection mechanism uses data received from the sensor to detect suspicious defects or areas, which may enable better performance of the parameters setup. The detection mechanism may optionally compare its results to a reference stored in the memory component, or in a database. The memory component saves images of detected areas acquired by the sensor, may only save the location of a detected area, and additionally, may save data relating to the reason which caused a defect to be detected by the detection mechanism.

The system contains a display mechanism showing the user live image of at least one of the detected areas, which could be a color, a grey-level or binary image, or user images that are stored in the memory component. Optionally, the display can show images that are elaborated, by using mathematical or optical filters, or display additional data relating to the reason for detecting a defect to be detected by the detection mechanism, or additional data regarding the features of the displayed image.

The system further comprises a per-se known user interface, enabling sorting of displayed defects into critical and non-critical defects. The decision-making mechanism is used to define a desirable ratio between defect types, set to obtain new parameters setups detecting a new map of defects, all of which are contained in a database of predefined types of defect, using mathematical and/or logical functions. Optionally, the mathematical function can be a cost function refined during a parameters setting process, in order to receive optimal results.

The searching mechanism analyzes the defect-sorted data, for obtaining new parameters setups, using a heuristic approach, during which, various parameter setups are tested each time, creating a new map of defects. The best defect map, and consequently the best parameters setups, are chosen to be the new parameters setups. The parameters setups are determined according to heuristic analysis only, or in combination with a deterministic approach, in which, upon receiving the sorted defects-map and the parameters of detection in some or each of the sorted defects, each parameter is set in order to reach the best new defect map. Optionally, at least one of the parameters setups is determined from several spatial or color resolutions in a hierarchal manner.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method for establishing a parameters setup for inspecting a plurality of articles by an automatic inspection system, said method comprising the steps of:
inspecting a first article by said inspection system;
applying an automatic defects detection method according to a given set of inspection parameters;
receiving an initial map of defects;
sorting uncovered defects into defect types according to a predetermined set of defect types;
while sorting defects, if new defects not recognized by said inspection system are detected, adding said new defects to said initial map to be sorted;
automatically setting said inspection parameters by means of applying computational dedicated algorithms, using a heuristic approach, to form a modified parameters setup;
using the modified parameters setup for obtaining a modified map of detected defects, and
using said modified parameters setup for inspecting other of said plurality of articles.

2. The method as claimed in claim 1, further comprising inspecting additional articles by the same method for further refining said modified parameters setup.

3. The method as claimed in claim 1, wherein the inspection is effected by scanning said inspected article with an automatic optical inspection system.

4. The method as claimed in claim 1, wherein said method is automatically performed by a controller.

5. The method as claimed in claim 1, wherein said sorting is effected manually by a professional operator.

6. The method as claimed in claim 1, wherein said sorting is effected using live video images.

7. The method as claimed in claim 1, wherein said sorting is effected using images stored in memory components.

8. The method as claimed in claim 1, wherein said sorting is effected from a remote location.

9. The method as claimed in claim 1, wherein said initial map of defects is obtained by inspecting said article while inspection parameters are set on values representing high detection sensitivity.

10. The method as claimed in claim 1, wherein said defect types are categorized as critical and non-critical defects.

11. The method as claimed in claim 1, wherein said heuristic approach comprises the steps of:
testing various parameters setups forming a modified map of defects, and
choosing the combination of parameters providing optimal detection results.

12. The method as claimed in claim 11, wherein at least one of said parameters setups is determined according to dedicated algorithms.

13. The method as claimed in claim 12, wherein said algorithms analyze the sorted defects, for obtaining the modified parameters set, using a deterministic approach, in which upon receiving said sorted defects map and the parameters of detection in some or each of sorted defects, each parameter is set in order to reach best modified defects map.

14. The method as claimed in claim 1, wherein dedicated rules are used to define a desirable ratio between defect types.

15. The method as claimed in claim 14, wherein said rules are set to obtain modified parameters setups detecting a modified map of defects, contained in a database of predefined defect types.

16. The method as claimed in claim 15, wherein said rules are implemented using at least one mathematical and/or logical function.

17. The method as claimed in claim 16, wherein said mathematical function is a cost function.

18. The method as claimed in claim 14, wherein said rules are refined during parameters setting process for receiving optimal results.

19. The method as claimed in claim 1, wherein at least one of said parameters setups is determined from several spatial or color resolutions in a hierarchal manner.

20. The method according to claim 1, wherein the parameter setup is operative to control all parameters of the system.

21. A system for establishing a parameters setup for inspecting a plurality of articles, comprising:
an inspection system for inspecting a first article of a batch forming an initial map of defects, and a controller operative for:
receiving said initial map of defects from said inspection system;
displaying each of said defects of said initial map-enabling an operator to sort each defect by types of defects and to enter the sorting into the system;
using dedicated algorithms to establish a modified parameters setup for receiving a modified defects map having a desirable ratio between true defects and false defects, and
providing said parameters setup for inspecting other articles of said batch.

22. The system as claimed in claim 20, wherein said parameters setup is operative to control all parameters of the system.

23. A system for automatic or semi-automatic establishing parameters setup for inspecting a plurality of articles, comprising:
a sensor for imaging a region of an inspected article;
a detection mechanism for choosing locations on said article for elaboration or display;
a memory capable of saving images of detected areas acquired by said sensor;
a decision-making unit for obtaining an optimal defect map;
a searching mechanism for finding parameter values that yield optimal results as defined by the decision-making unit, and
means providing parameter values for inspecting other articles of said batch.

24. The system as claimed in claim 23, wherein said sensor is chosen from the group of sensors sensitive to parts of the electromagnetic spectrum, including visible light; line, array or TDI sensors, or color or grey-level sensors.

25. The system as claimed in claim 23, wherein said detection mechanism is chosen from the group of: a detection mechanism using data received from said sensor; a defect detection mechanism; a mechanism detecting suspected defects and areas enabling better performance of said parameters set, and a detection mechanism detecting suspicious areas in the inspected article with or without comparison to a stored reference.

26. The system as claimed in claim 23, wherein said memory is capable of saving locations of detected areas.

27. The system as claimed in claim 23, wherein said memory is capable of saving data indicative of a reason causing it to be detected by said detection mechanism.

28. The system as claimed in claim 23, further comprising a display.

29. The system as claimed in claim 28, wherein said display exhibits live images of at least one of the detected areas, in the form selected from the group of images: color, gray-level or binary images.

30. The system as claimed in claim 28, wherein the display exhibits images retrieved from said memory.

31. The system as claimed in claim 28, wherein said display exhibits images elaborated by using mathematical or optical filters.

32. The system as claimed in claim 28, wherein said display exhibits data indicative of the reason causing defects to be detected by said detection mechanism.

33. The system as claimed in claim 28, wherein said display exhibits additional data concerning the features of said images.

34. The system as claimed in claim 23, further comprising a user interface, enabling sorting defects into critical and non-critical defects.

35. The system as claimed in claim 23, wherein said decision-making unit is capable of defining a desirable ratio between defect types.

36. The system as claimed in claim 35, wherein said decision-making unit is set to obtain said modified parameters setup, for detecting a modified map of defects contained in a database of predefined defect types.

37. The system as claimed in claim 35, wherein said decision-making unit is implemented for using at least one mathematical and/or logical function.

38. The system as claimed in claim 37, wherein said mathematical function is a cost function.

39. The system as claimed in claim 35, wherein said decision-making unit is refined during the parameters setting process for receiving optimal results.

40. The system as claimed in claim 23, wherein the searching mechanism is used to obtain the new parameters setup.

41. The system as claimed in claim 23, wherein said searching mechanism analyzes sorted defects for obtaining the modified parameters setup, using a heuristic approach.

42. The system as claimed in claim 41, wherein said heuristic approach comprises:
testing various parameters setups for forming a modified map of defects, and
choosing the combination of parameters providing optimal detection results.

43. The system as claimed in claim 23, wherein said searching mechanism analyzes defect sorted data for obtaining the modified parameters setup, using a deterministic approach.

44. The system as claimed in claim 43, wherein said deterministic approach comprises:
upon receiving said sorted defects map and the parameters of detection in some or each of the sorted defects, each parameter is set in order for reaching the best modified defect map.

45. The system as claimed in claim 23, wherein said parameters setup is operative to control all parameters of the system.
